(19) United States
(12) Patent Application Publication
(10) Pub. No.: US 2008/0040016 A1
(43) Pub. Date: Feb. 14, 2008

(54) Controller of motor for vehicle

(75) Inventor: Naoki Fujishiro, Kawachi-gun (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD.

(21) Appl. No.: 11/890,479

(22) Filed: Aug. 7, 2007

(30) Foreign Application Priority Data
Aug. 9, 2006 (JP) 2006-217035

(51) Int. Cl. B60L 15/20; B60W 20/00

(52) U.S. Cl. 701/99; 903/902

(57) ABSTRACT

A controller of a motor for a vehicle includes: a motor that has a plurality of rotors which respectively have a magnetic piece, and for which mutual relative phases are changeable, which drives or supplementarily drives a vehicle; a phase changing device that changes the relative phases of the plurality of rotors and performs adjustment to a predetermined induced voltage constant; a measuring device that measures an acceleration state quantity of the vehicle; and an induced voltage changing device that changes the induced voltage constant based on the acceleration state quantity measured by the measuring device.

### BACKGROUND OF THE INVENTION

Priority is claimed on Japanese Patent Application No. 2006-217035, filed Aug. 9, 2006, the contents of which are incorporated herein by reference.

1. Field of the Invention

The present invention relates to a controller of a motor for a vehicle.

2. Description of the Related Art

Heretofore, in regard to motors for vehicles such as hybrid vehicles, those in which a plurality of rotors which are provided with magnetic poles with polarities that are serially different in the rotation direction, are arranged on the same rotation axis such that they are adjacent, and the induced voltage constant of a permanent magnet with respect to the stators is adjusted by changing the spacing of these rotors by means of an actuator, are known (for example, refer to Japanese Unexamined Patent Application, First Publication No. 2001-69609).

Incidentally, in a controller of a motor for a vehicle according to the one example of conventional technology mentioned above, the range of motor torque that is able to be output, and the range of the motor revolution speed, is changed by changing the induced voltage constant according to the motor revolution speed, for example, by making it a weak magnetic field in the case of high revolutions, and a strong magnetic field in the case of low revolutions. However, in such a controller, even if there is a motor torque that is able to be output on the motor side under traveling circumstances such as where the driver desires an increase in motor torque, since the gradient of the induced voltage constant with respect to the motor revolution speed is constant, there are cases where the motor torque that is necessary for the driving intended by the driver cannot be obtained.

Consequently, the present invention was made in view of the aforementioned circumstances and has an object of providing a controller of a motor for a vehicle in which appropriate motor characteristics that correspond to the driving preferences of the driver can be provided.

### SUMMARY OF THE INVENTION

In order to achieve the aforementioned object, the present invention employs the followings.

That is to say, the controller of a motor for a vehicle of the present invention includes: a motor that has a plurality of rotors which respectively have a magnetic piece, and for which mutual relative phases are changeable, which drives or supplementarily drives a vehicle; a phase changing device that changes the relative phases of the plurality of rotors and performs adjustment to a predetermined induced voltage constant; a measuring device that measures an acceleration state quantity of the vehicle; and an induced voltage changing device that changes the induced voltage constant based on the acceleration state quantity measured by the measuring device.

According to this controller of a motor for a vehicle, the induced voltage constant can be changed by the phase changing device based on the acceleration (for example, the longitudinal acceleration, the transverse acceleration, or the like) or the acceleration state quantity (for example, the torque command value, or the like) of the vehicle measured by the measuring device. Accordingly, the driving preferences of the driver are determined; for example, an improvement in drivability is demanded by the driver in a case where the acceleration state quantity is large, and economical driving is demanded when the acceleration state quantity is small, and the induced voltage constant can be changed to an induced voltage constant that corresponds to these driving preferences. Therefore, appropriate motor characteristics that correspond to the driving preferences of the driver can be provided with respect to the motor.

The phase changing device may be made to change the induced voltage constant according to a magnitude of an average value of the acceleration state quantity within a fixed interval.

In this case, for example, the behavior of the motor that appears as a result of a change in the induced voltage constant can be changed more gradually in the case where the induced voltage constant is changed using the average value of the acceleration state quantity than in the case where the induced voltage constant is changed according to merely the acceleration state quantity. Accordingly, appropriate characteristics that correspond to the driving preferences of the driver can be more smoothly provided to the motor.

The phase changing device may be furnished with maps of induced voltage constants, in which a plurality have been set, and it may be made to select one map from within the plurality of maps according to a magnitude of an average value of the acceleration state quantity at a fixed interval.

In this case, a map of the induced voltage constant that corresponds to the average value of acceleration state quantity at a fixed interval can be selected. Accordingly, appropriate motor characteristics can be obtained by changing to an induced voltage constant that corresponds to the driving preferences of the driver.

A reporting device that reports driving preferences of a driver according to a magnitude of an average value of the acceleration state quantity at a fixed interval may be further provided.

In this case, the driving preferences of the driver are determined according to the magnitude of the average value of the acceleration state quantity at a fixed interval, and these determined driving preferences can be reported to the driver. Accordingly, for example, the driver is able to confirm the driver's own objective driving preferences and make it a reference for future driving.

The phase changing device may be furnished with a manual operation device in which the maps are able to be manually changed and fixed.

In this case, the driver is able to select a map of the induced voltage constant manually by means of the manual operation device and make it a fixed state such that it is not changed thereafter. Accordingly, motor characteristics corresponding to the driving preferences desired by the driver can be obtained without depending on the acceleration state quantity.

### BRIEF DESCRIPTION OF THE DRAWINGS

FIG. 1 is a block diagram of a controller of a motor for a vehicle according to one embodiment of the present invention.

FIG. 2 is a cross-sectional view of a motor according to the same embodiment.

FIG. 3A is a drawing schematically showing a strong magnetic field state in which a permanent magnet of an inner periphery side rotor and a permanent magnet of an outer periphery side rotor of the same motor are in an unlike-pole facing arrangement. Furthermore, FIG. 3B is a drawing schematically showing a weak magnetic field state in which the permanent magnet on the inner periphery side rotor and the permanent magnet on the outer periphery side rotor of the same motor are in a like-pole facing arrangement.

FIG. 4 is maps of the induced voltage constant Ke according to the same embodiment.

FIG. 5 is a flowchart showing a map exchanging process according to the same embodiment.

### DETAILED DESCRIPTION OF THE INVENTION

One embodiment of a controller of a motor for a vehicle according to the present invention will be described below with reference to the drawings.

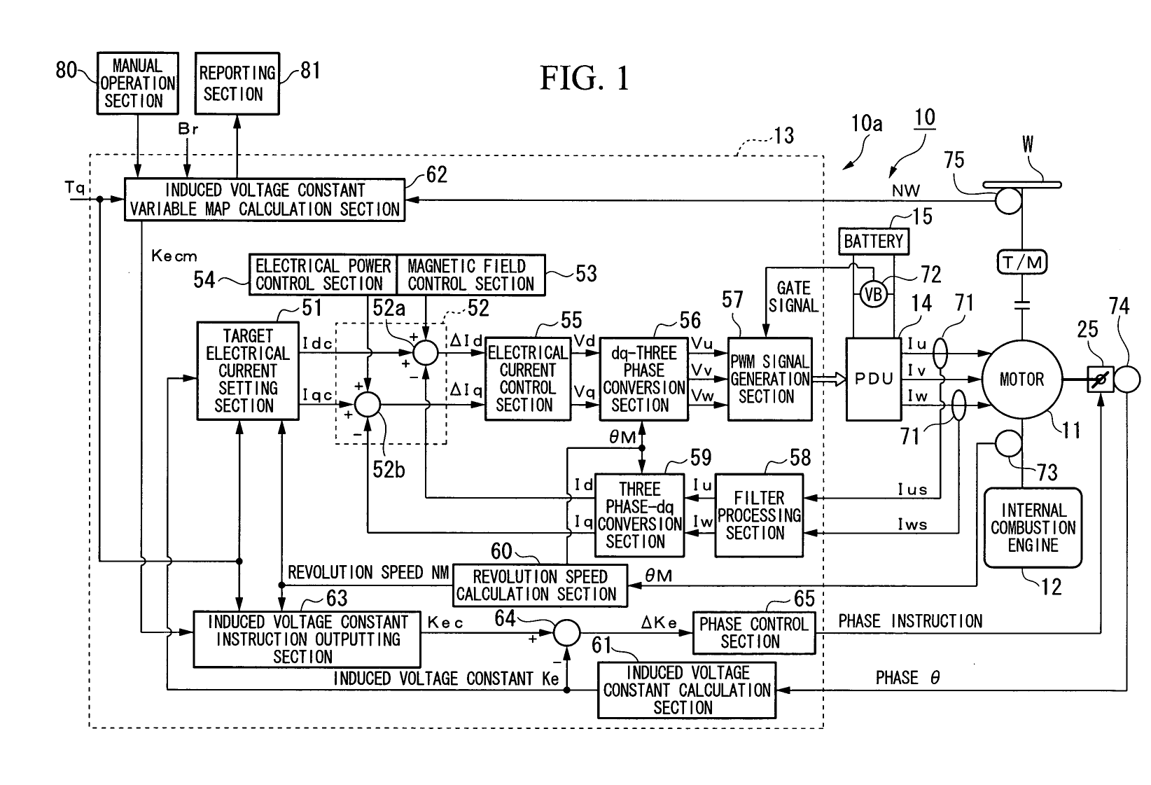

A controller of a motor for a vehicle 10a according to the present invention is, for example, installed in a vehicle 10 such as a hybrid vehicle or an electric vehicle, which is furnished with a motor as the propulsion driving source. For example, the vehicle 10 shown in FIG. 1 is a parallel hybrid vehicle in which a motor 11 and an internal combustion engine 12 are furnished as the driving source, the motor 11, the internal combustion engine 12, and the transmission T/M are directly connected in series, and it is made such that, at the very least, the driving force of the motor 11 or the internal combustion engine 12 is transmitted to the driving wheel W of the vehicle via the transmission T/M.

Moreover, when a driving force is transmitted to the motor 11 from the driving wheel W side at the time of deceleration of the vehicle 10, the motor 11 functions as an electrical generator and generates a so-called regenerative braking force, and the kinetic energy of the vehicle body is recovered as electrical energy (regenerative energy). Furthermore, in a case where the output of the internal combustion engine 12 is transmitted to the motor 11, the motor 11 also functions as an electrical generator, and generates electrical energy.

In the vehicle 10, driving of the plurality of phases (for example, the three phases of the U-phase, the V-phase and the W-phase) of the motor 11, and the regeneration operation, are performed by means of a power drive unit (PDU) 14 by receiving a control instruction that is output from the control section 13.

The PDU 14 is, for example, furnished with a PWM inverter which uses pulse width modulation (PWM), and that has a bridge circuit in which a plurality of switching elements of transistors are used and bridge connected, and is connected to a high voltage type battery 15 that performs transfer of the electrical energy with the motor 11.

In regard to the PDU 14, for example, by switching the ON (conducting)/OFF (disconnected) state of the transistors, which form a pair for each phase in the PWM inverter, based on a gate signal (that is, the PWM signal) which is a switching instruction that is input from the control section 13 at the time of driving of the motor 11, or the like, the direct current power that is supplied from the battery 15 is converted into three-phase alternating current power, and by serially commuting the energization to the stator winding of the three-phase motor 11, a U-phase electrical current Iu, a V-phase electrical current Iv, and a W-phase electrical current Iw, which are alternating currents, are energized to the stator windings of each phase.

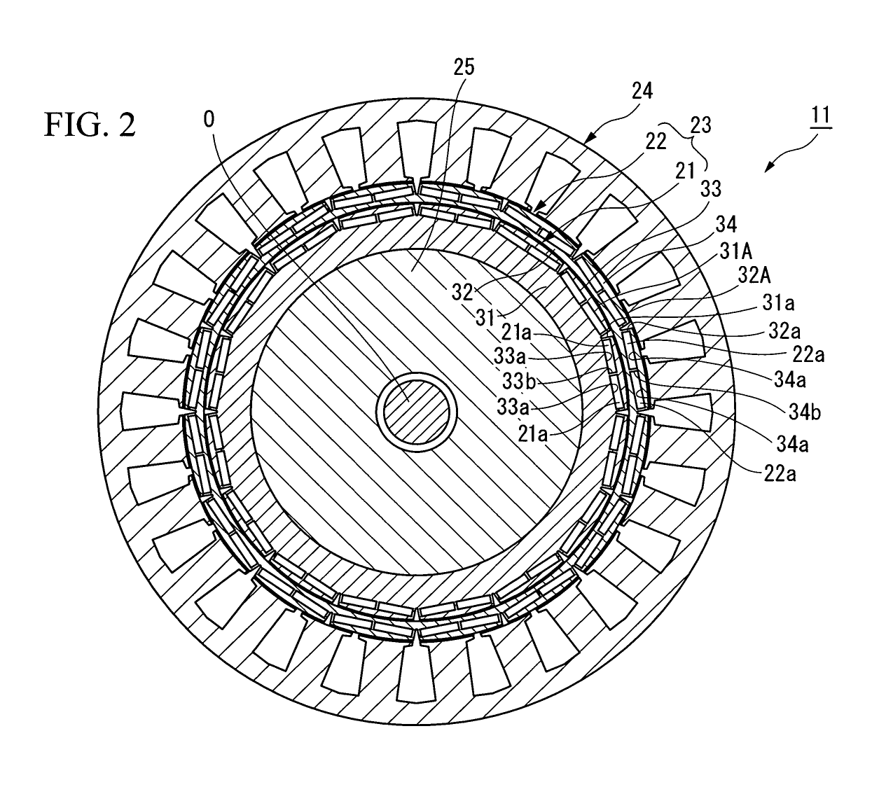

The motor 11 is, for example, as shown in FIG. 2, furnished with: a rotor 23 having an inner periphery side rotor 21 and an outer periphery side rotor 22 that are approximately toric, which have permanent magnets (magnetic pieces) 21a and 22a that are arranged around the circumferential direction; a stator 24 which has a plurality of phases of stator windings (not shown in the drawing), that generates a rotating magnetic field that rotates the rotor 23; and a phase control device 25 that controls the relative phases between the inner periphery side rotor 21 and the outer periphery side rotor 22. The phase control device 25 is, for example, one that changes the relative phases between the inner periphery side rotor 21 and the outer periphery side rotor 22 by using oil pressure or a motor.

The inner periphery side rotor 21 and the outer periphery side rotor 22 are arranged such that their mutual rotation axes become the same axis as the rotation axis O of the motor 11. They are furnished with: approximately cylindrical rotor cores 31 and 32; a plurality of inner peripheral magnet mounting attachments 33 which are provided at fixed intervals in the circumferential direction on the outer peripheral section of the first rotor core 31; and a plurality of outer peripheral magnet mounting attachments 34 which are provided at fixed intervals in the circumferential direction on the interior of the second rotor core 32.

Moreover in the intervals between inner peripheral magnet mounting attachments 33 that are adjacent in the circumferential direction, a concave groove 31a that extends parallel to the rotation axis O is formed on the outer peripheral surface 31A of the first rotor core 31.

Furthermore, in the intervals between outer peripheral magnet mounting attachments 34 that are adjacent in the circumferential direction, a concave groove 32a that extends parallel to the rotation axis O is formed on the outer peripheral surface 32A of the second rotor core 32.

The magnet mounting attachments 33 and 34, for example, are furnished with pairs of magnet mounting holes 33a and 34a that pass through parallel to the rotation axis O, and they are arranged such that the pair of magnet mounting holes 33a are adjacent in the circumferential direction via the center rib 33b, and the pair of magnet mounting holes 34a are adjacent in the circumferential direction via the center rib 34b.

Moreover, in regard to the magnet mounting holes 33a and 34a, the cross-section with respect to the direction parallel to the rotation axis O is formed in an approximately rectangular shape in which the approximately circumferential direction is the longer dimension direction and the approximately radial direction is the shorter dimension direction, and approximately rectangular shaped plate form permanent magnets 21a and 22a that extend parallel to the rotation axis O are mounted in the magnet mounting holes 33a and 34a.

The pair of inner peripheral permanent magnets 21a that are mounted in the pair of magnet mounting holes 33a are magnetized in the thickness direction (that is, in the radial direction of the rotors 21 and 22), and are set such that the mutual magnetization directions are the same direction. Moreover, with respect to the inner peripheral magnet mounting attachments 33 which are adjacent in the circumferential direction, the pairs of inner peripheral permanent magnets 21a and inner peripheral permanent magnets 21a that are mounted in the pairs of magnet mounting holes 33a and 33a, are set such that the mutual magnetization directions are different directions. That is to say, the inner peripheral magnet mounting attachment 33 to which a pair of inner peripheral permanent magnets 21a have been mounted, in which the outer periphery has been made the S-pole, is made to be adjacent in the circumferential direction to the inner peripheral magnet mounting attachment 33 to which a pair of inner peripheral permanent magnets 21a have been mounted, in which the outer periphery has been made the N-pole, via the concave groove 31a.

In the same manner, the pair of outer peripheral permanent magnets 22a that are mounted in the pair of magnet mounting holes 34a are magnetized in the thickness direction (that is, in the radial direction of the rotors 21 and 22), and are set such that the mutual magnetization directions are the same direction. Furthermore, with respect to the outer peripheral magnet mounting attachments 34 which are adjacent in the circumferential direction, the pairs of outer peripheral permanent magnets 22a and outer peripheral permanent magnets 22a that are mounted in the pairs of magnet mounting holes 34a and 34a, are set such that the mutual magnetization directions are different directions. That is to say, the outer peripheral magnet mounting attachment 34 to which a pair of outer peripheral permanent magnets 22a have been mounted, in which the outer periphery has been made the S-pole, is made to be adjacent in the circumferential direction to the outer peripheral magnet mounting attachment 34 to which a pair of outer peripheral permanent magnets 22a have been mounted, in which the outer periphery has been made the N-pole, via the concave groove 32a.

Moreover, the magnet mounting attachments 33 of the inner periphery side rotor 21 and the magnet mounting attachments 34 of the outer periphery side rotor 22, and furthermore, the concave grooves 31a of the inner periphery side rotor 21 and the concave grooves 32a of the outer periphery side rotor 22, are arranged so that they are arrangable such that they mutually oppose in the radial direction of the rotors 21 and 22.

Consequently, according to the relative position of the inner periphery side rotor 21 and the outer periphery side rotor 22 about the rotation axis O, the state of the motor 11 is able to be set to an appropriate state ranging from a weak magnetic field state, in which the like-poles of the magnetic poles of the inner peripheral permanent magnet 21a of the inner periphery side rotor 21 and the outer peripheral permanent magnet 22a of the outer periphery side rotor 22 are opposingly arranged (that is, the inner peripheral permanent magnet 21a and the outer peripheral permanent magnet 22a are in a like-pole facing arrangement), to a strong magnetic field state, in which the unlike-poles of the magnetic poles of inner peripheral permanent magnet 21a of the inner periphery side rotor 21 and the outer peripheral permanent magnet 22a of the outer periphery side rotor 22 are opposingly arranged (that is, the inner peripheral permanent magnet 21a and the outer peripheral permanent magnet 22a are in an unlike-pole facing arrangement).

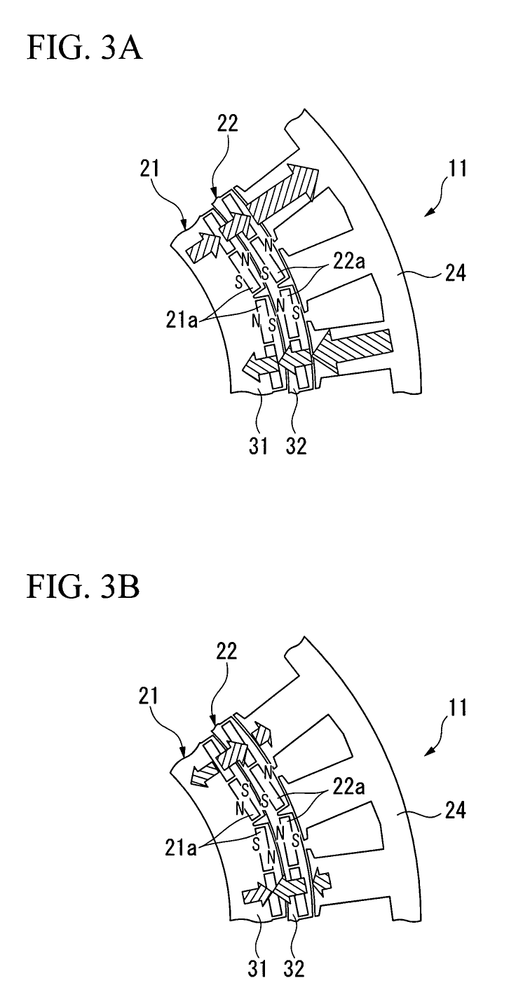

Here, in the case of the motor 11 of this embodiment, it is set such that when the inner periphery side rotor 21 is in the maximum lag angle position with respect to the outer periphery side rotor 22, the permanent magnets 21a and 22a of the inner periphery side rotor 21 and the outer periphery side rotor 22 oppose by way of the unlike-poles and it becomes the strong magnetic field state (refer to FIG. 3A), and when the inner periphery side rotor 21 is in the maximum advance angle position with respect to the outer periphery side rotor 22, the permanent magnets 21a and 22b of the inner periphery side rotor 21 and the outer periphery side rotor 22 oppose by way of the like-poles and it becomes the weak magnetic field state (refer to FIG. 3B).

Although this motor 11 is one in which the strong magnetic field state and the weak magnetic field state may be arbitrarily changed by means of supply and discharge control of a hydraulic fluid, when the magnetic field strength is changed in this manner, this is accompanied by a change in the induced voltage constant Ke, and as a result, the characteristics of the motor 11 are changed. That is to say, although the allowed revolution speed at which the motor 11 is drivable decreases when the induced voltage constant Ke becomes large as a result of a strong magnetic field, the maximum torque that can be output increases. Conversely, although the maximum torque that can be output by the motor 11 decreases when the induced voltage constant Ke becomes small as a result of a weak magnetic field, the allowed revolution speed at which it is drivable increases.

The control section 13 performs electrical current feedback control in dq coordinates which constitute rotating orthogonal coordinates, and, for example, calculates the d-axis electrical current instruction Idc and the q-axis electrical current instruction Iqc which are set based on the torque instruction value Tq that is set based on the measurement result of an accelerator opening sensor that measures the opening of the accelerator relating to the accelerator operation of the driver. Moreover the control section 13 calculates the phase output voltages Vu, Vv, and Vw based on the d-axis electrical current instruction Idc and the q-axis electrical current instruction Iqc, and as well as inputting a PWM signal, which is a gate signal, to the PDU 14, according to the phase output voltages Vu, Vv, and Vw, it performs a control such that the deviation between the d-axis electrical current Id and the q-axis electrical current Iq, which are obtained by converting two phase electrical currents amongst the phase electrical currents Iu, Iv, and Iw, which are actually supplied from the PDU 14 to the motor 11, into electrical currents in dq coordinates, and the deviation between the d-axis electrical current instruction Idc and the q-axis electrical current instruction Iqc, become zero.

This control section 13 is configured for example by; a target electrical current setting section (correction device) 51, an electrical current deviation calculation section 52, a magnetic field control section 53, an electrical power control section 54, an electrical current control section 55, a dq-three phase conversion section 56, a PWM signal generation section 57, a filter processing section 58, a three phase-dq conversion section 59, a revolution speed calculation section 60, an induced voltage constant calculation section 61, an induced voltage constant variable map calculation section (induced voltage changing device) 62, an induced voltage constant instruction outputting section 63, an induced voltage constant difference calculation section 64, and a phase control section (phase changing device, correction device) 65.

Furthermore, to this control section 13 are input: measurement signals lus and Iws that are output from the electrical current sensors 71 which measure the two phases of the U-phase electrical current Iu and the W-phase electrical current Iw amongst the three phases of electrical currents Iu, Iv, and Iw that are output from the PDU 14 to the motor 11; a measurement signal that is output from a voltage sensor 72 which measures the terminal voltage (power source voltage) VB of the battery 15; a measurement signal output from a rotation sensor 73 which measures the rotation angle θM of the rotors of the motor 11 (that is, the rotation angle of the magnetic poles of the rotors from a predetermined reference rotation position); a measurement signal output from the phase sensor (measuring device) 74 which measures the relative phase θ between the inner periphery side rotor 21 and the outer periphery side rotor 22, which are variably controlled by the phase control device 25; and a measurement signal that is output from a plurality of wheel speed sensors 75 which measure the rotation speed (wheel speed NW) of the wheels of the vehicle 10.

The target electrical current setting section 51 calculates for example; an electric current instruction for specifying the phase electrical currents Iu, Iv, and Iw that are supplied from the PDU 14 to the motor 11 based on the torque instruction value Tq (for example, an instruction value for generating the necessary torque in the motor 11 according to the output from the accelerator opening sensor, which measures the depression operation amount of the accelerator pedal AP by the driver) that is input from a control device (not shown in the drawing) on the exterior, the revolution speed NM of the motor 11 which is input from the revolution speed calculation section 60, and the induced voltage constant Ke which is input from the induced voltage constant calculation section 61 mentioned below, and this electrical current instruction is output to the electrical current deviation calculation section 52 as a d-axis electrical current instruction Idc and a q-axis electrical current instruction Iqc in rotating orthogonal coordinates.

In regard to the dq coordinates which constitute these rotating orthogonal coordinates, for example, the magnetic flux of the field pole resulting from the permanent magnets of the rotors is made the d-axis (magnetic field axis), and the direction that is perpendicular to this d-axis is made the q-axis (torque axis), and they are rotated with the same period as the rotation phase of the rotor 23 of the motor 11. Consequently, the d-axis electrical current instruction Idc and the q-axis electrical current instruction Iqc, which are direct current signals, are provided as an electrical current instruction corresponding to the alternating current signal that is provided from the PDU 14 to the phases of the motor 11.

The electrical current deviation calculation section 52 is configured by; a d-axis electrical current deviation calculation section 52a that calculates the deviation ΔId between the d-axis electrical current instruction Idc, to which a d-axis correction electrical current input from the magnetic field control section 53 has been added, and the d-axis electrical current Id, and a q-axis electrical current deviation calculation section 52b that calculates the deviation ΔIq between the q-axis electrical current instruction Iqc, to which a q-axis correction electrical current input from the electrical power control section 54 has been added, and the q-axis electrical current Iq.

The magnetic field control section 53, for example, equivalently weakens the magnetic field quantities of the rotor 23 in order to control the increase in counter-electromotive force that accompanies the increase in the revolution speed NM of the motor 11, and outputs the target value with respect to the weak field current of the weak magnetic field control which controls the electrical current phases, to the d-axis electrical current deviation calculation section 52a as the d-axis correction electrical current.

Furthermore, the electrical power control section 54, for example, outputs the q-axis correction electrical current for correcting the q-axis electrical current instruction Iqc according to an appropriate electrical power control corresponding to the remaining charge of the battery 15, or the like, to the q-axis electrical current deviation calculation section 52a.

The electrical current control section 55, for example, by means of a PI (proportional integral) corresponding to the revolution speed NM of the motor 11, performs controlled amplification of the deviation ΔId and calculates the d-axis voltage instruction value Vd, and performs controlled amplification of the deviation ΔIq and calculates the q-axis voltage instruction value Vq.

The dq-three phase conversion section 56 uses the rotation angle θM of the rotor 23 that is input from the revolution speed calculation section 60, and converts the d-axis voltage instruction value Vd and the q-axis voltage instruction value Vq, which are in dq coordinates, into a U-phase output voltage Vu, a V-phase output voltage Vv, and a W-phase output voltage Vw, which are voltage instruction values in three-phase alternating current coordinates, which are static coordinates.

The PWM signal generation section 57, for example, by means of; the sine wave form phase output voltages Vu, Vv, and Vw, a carrier signal including a triangular wave, and pulse width modulation based on the switching frequency, generates a gate signal (that is, a PWM signal) which is a switching instruction including the pulses that drive the switching elements of the PWM inverter of the PDU 14 ON and OFF.

The filter processing section 58 performs filter processing, such as removal of high frequency components, with respect to the measurement signals Ius and Iws of the phase electrical currents measured by the electrical current sensors 71, and extracts the phase electrical currents Iu and Iw as physical quantities.

The three phase-dq conversion section 59 calculates the d-axis electrical current Id and the q-axis electrical current Iq in dq coordinates, that is to say, the rotation coordinates resulting from the rotation phases of the motor 11, by means of the phase electrical currents Iu and Iw extracted from the filter processing section 58 and the rotation angle θM of the rotor 23 that is input from the revolution speed calculation section 60.

The revolution speed calculation section 60, as well as extracting the rotation angle θM of the rotor 23 of the motor 11 from the measurement signal output from the rotation sensor 73, calculates the revolution speed NM of the motor 11 based on this rotation angle θM.

The induced voltage constant calculation section 61 calculates the induced voltage constant Ke corresponding to the relative phase θ between the inner periphery side rotor 21 and the outer periphery side rotor 22 based on the measurement signal of the phase θ output from the phase sensor 74.

The induced voltage constant instruction output section 63, for example, outputs the instruction value (induced voltage constant instruction value) Kec with respect to the induced voltage constant Ke of the motor 11, based on the torque instruction value Tq and the revolution speed NM of the motor 11.

The induced voltage constant difference calculation section 64 outputs the induced voltage constant difference ΔKe which is the deviation between the induced voltage constant instruction value Kec that is output from the induced voltage constant instruction output section 63 and the induced voltage constant Ke that is output from the induced voltage constant calculation section 61.

The phase control section 65, for example, according to the induced voltage constant difference ΔKe that is output from the induced voltage constant difference calculation section 64, outputs a control instruction for controlling the phase θ by making this induced voltage constant difference ΔKe zero.

Incidentally, an induced voltage constant variable map calculation section 62, which is furnished with a plurality of maps for the vehicle speed and the induced voltage constant Ke, is provided in the control section 13.

This induced voltage constant variable map calculation section 62 calculates the longitudinal acceleration and the transverse acceleration, which represent acceleration of the vehicle, based on the wheel speed NW measured by the wheel speed sensor 75, calculates the average value (hereunder simply referred to as G history) of this longitudinal acceleration and transverse acceleration at a fixed interval (for example, distance or time), determines the driving preferences (for example, fuel-efficient economical driving or a priority on performance) of the driver based on this G history, and selects a map according to these driving preferences. Then, the induced voltage constant variable map calculation section 62 retrieves the induced voltage constant Ke from the wheel speed based on the selected map, and outputs the instruction value Kecm of this induced voltage constant Ke for obtaining the retrieved induced voltage constant Ke. Here, the instruction value Kecm is input to the aforementioned induced voltage constant instruction output section 63, and the instruction value Kecm is output as the induced voltage constant instruction value Kec, at the induced voltage constant instruction output section 63.

Furthermore, a manual operation section (manual operation device) 80 for map selection is connected to the induced voltage constant variable map calculation section 62, and as a result of the driver operating this manual operation section 80, the determination of the driving preferences by means of the G history mentioned above is ignored, and the instruction value Kecm retrieved using the map selected by the manual operation section 80 is forced to be output. Here, until changes or releasing is performed by means of operation of the manual operation 80, it becomes a fixed state such that the selected map is not changed.

Moreover, a reporting section (reporting device) 81 that reports the aforementioned driving preferences to the driver, is connected to the induced voltage constant variable map calculation section 62. This reporting section 81, in regard to the driving preferences that have been determined based on the acceleration, reports these as audio using a speaker, or performs displaying that shows the driving preferences on a display, such as a head up display (HUD) or a navigation device.

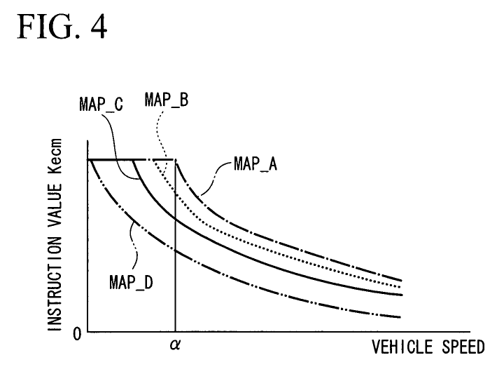

FIG. 4 shows an example of a plurality of maps (MAP) for a case where the vertical axis is made the induced voltage constant Ke, and the horizontal axis is made the vehicle speed. In this FIG. 4, for example, four maps, that is, MAP_A, MAP_B, MAP_C, and MAP_D, are prepared, and although the respective gradients are approximately the same when viewed at the same vehicle speed above a vehicle speed α, it is a relationship in which MAP_A>MAP_B>MAP_C>MAP_D. In this case, MAP_D is a map that is applied when the driving preference is economical driving, and MAP_C is a map that is applied when the driving preference is standard normal driving. Furthermore, MAP_B is a map that is applied when the driving preference is driving in which priority is placed somewhat more on performance than for normal driving, and MAP_A is a map that is applied when the driving preference is driving in which priority is placed on the performance. Here, at a predetermined vehicle speed below the vehicle speed α, in regard to MAP_A to MAP_D, the serial instruction values Kecm become maximum values and transition at a fixed value. Here, driving in which a priority is placed on the performance refers to driving in the manner of so-called sports driving.

That is to say, since the output of the instruction value Kecm with respect to the vehicle speed becomes the largest for the case where MAP_A is used, it is hence controlled by the strong magnetic field side, in which the relative phase θ between the inner periphery side rotor 21 and the outer periphery side rotor 22 becomes the lag angle side, and although the power consumption of the motor 11 increases, the torque of the motor increases and a dynamic driving feel can be obtained.

On the other hand, since the output of the instruction value Kecm with respect to the vehicle speed becomes the smallest for the case where MAP_D is used, it is hence controlled by the weak magnetic field side, in which the relative phase θ between the inner periphery side rotor 21 and the outer periphery side rotor 22 becomes the advance angle side, and although the torque of the motor decreases, the power consumption of the motor is controlled by that amount thereof, and economical driving is possible.

Moreover, in regard to MAP_B and MAP_C, intermediate characteristics between MAP_A and MAP_D respectively mentioned above can be obtained.

The control device of a motor for a vehicle 10a of the present invention is furnished with the aforementioned configuration. Next, the operation of the control device 10a, in particular, the map exchanging process which selects a map according to the driving preferences of the driver, is described with reference to the appended drawing.

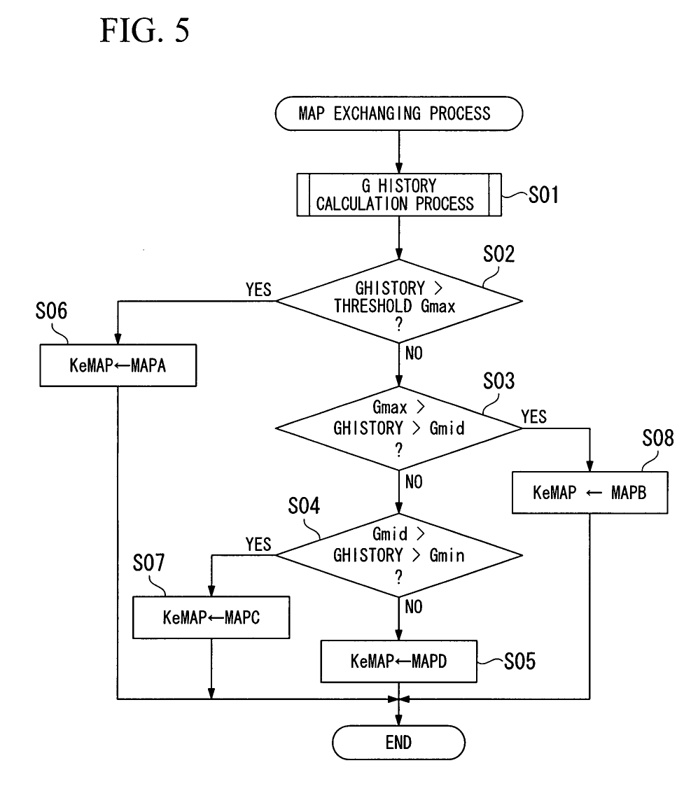

Firstly, in step S01 shown in FIG. 5, a G history calculation process is performed, and the G history is calculated. That is to say, as mentioned above, the vehicle speed of the vehicle is calculated by the wheel speed from the wheel speed sensor 75, and based on this vehicle speed, the longitudinal acceleration and the transverse acceleration are calculated. Then, the average value (G history) of this longitudinal acceleration and transverse acceleration within a fixed time is calculated.

In step S02, it is determined whether the G history is larger than the threshold Gmax or not. When the determination is “YES” (G history>threshold Gmax), the flow proceeds to step S06, and when the determination is “NO” (G history≦threshold Gmax), the flow proceeds to step S03.

In step S03, it is determined whether the G history is smaller than the threshold Gmax and larger than the threshold Gmid or not. When in step S03 the determination is “YES” (threshold Gmax>G history>threshold Gmid), the flow proceeds to step S08, and when the determination is “NO” (threshold Gmax>G history>threshold Gmid does not hold), the flow proceeds to step S04.

In step S04, it is determined whether the G history is smaller than the threshold Gmid and larger than the threshold Gmin or not. When in step S04 the determination is “YES” (threshold Gmid>G history>threshold Gmin), the flow proceeds to step S07, and when the determination is “NO” (threshold Gmid>G history>threshold Gmin does not hold), the flow proceeds to step S05. Here, the threshold Gmax, the threshold Gmid, and the threshold Gmin are thresholds of the G history that are arbitrarily set in order to define the respective ranges of the driving preferences, and here, threshold Gmax>threshold Gmid>threshold Gmin.

In step S05, it is determined that the driving preference is economical driving, MAP_D of FIG. 4 mentioned above is selected as the map (KeMAP) of the induced voltage constant Ke, and the processing is completed.

In step S06, it is determined that the driving preference places a priority on the performance, MAP_A of FIG. 4 mentioned above is selected as the map (KeMAP) of the induced voltage constant Ke, and the processing is completed.

In step S07, it is determined that the driving preference is normal, MAP_C of FIG. 4 mentioned above is selected as the map (KeMAP) of the induced voltage constant Ke, and the processing is completed.

In step S08, it is determined that the driving preference somewhat places a priority on the performance more than normal, MAP_B of FIG. 4 mentioned above is selected as the map (KeMAP) of the induced voltage constant Ke, and the processing is completed.

As mentioned above, according to the control device of a motor for a vehicle 10a of the present embodiment, since the instruction value Kecm of the induced voltage constant Ke can be changed in the induced voltage constant variable map calculation section 62, based on the longitudinal acceleration and the transverse acceleration of the vehicle 10 which is calculated from the wheel speed measured by the wheel speed sensor 75, for example, the driving preferences of the driver can be determined, such as an improvement in drivability being sought by the driver in the case where the longitudinal acceleration or the transverse acceleration is large, or economical driving being sought in the case where the longitudinal acceleration or the transverse acceleration is small, and it is possible to change to an induced voltage constant Ke that corresponds to these driving preferences. Accordingly, it is possible to provide the appropriate motor characteristics with respect to the motor 11 corresponding to the driving preferences of the driver.

Furthermore, for example, since the behavior of the motor 11 that appears as a result of a change in the induced voltage constant Ke can be changed more gradually in the case where the induced voltage constant Ke is changed using the average value of the longitudinal acceleration or the transverse acceleration within a fixed time, than in the case where the induced voltage constant Ke is changed according to merely the longitudinal acceleration or the transverse acceleration, appropriate characteristics that correspond to the driving preferences of the driver can be more smoothly provided to the motor 11.

Moreover, since the appropriate map of the induced voltage constant Ke can be selected from within MAP_A, MAP_B, MAP_C, and MAP_D according to the average value of the longitudinal acceleration or the transverse acceleration within a fixed time, the appropriate motor characteristics can be obtained by changing to the induced voltage constant Ke that corresponds to the driving preferences of the driver.

Furthermore, the driving preferences of the driver are determined according to the magnitude of the average value of the longitudinal acceleration or the transverse acceleration within a fixed time, and since these determined driving preferences can be reported to the driver by means of the reporting section 81, for example, the driver is able to confirm the driver's own objective driving preferences and make it a reference for future driving.

Moreover, since the driver is able to manually select the desired map from within MAP_A, MAP_B, MAP_C, and MAP_D, in which each driving preference has been set, by means of the manual operation section 80, and it can be set to a fixed state such that it is not changed thereafter, the driver can obtain motor characteristics corresponding to the desired driving preferences without depending on the acceleration of the vehicle, that is, the driving preferences determined from the acceleration.

The present invention is in no way restricted to the aforementioned embodiment, and for example, it may be made a configuration in which the acceleration is calculated using an acceleration sensor that directly measures the acceleration.

Furthermore, in the aforementioned embodiment, although the driving preferences of the driver were determined based on the average value of the longitudinal acceleration or the transverse acceleration, the driving preferences may be made to be determined based on the instruction torque Tq, which corresponds to the acceleration pedal opening, or the brake depression force, as the acceleration state quantity, and for example, in the case the instruction Tq is used, the driving preferences may be determined using the average value (Tq history) of the instruction torque Tq within a fixed time. In this case, for example, although in the map exchanging process of FIG. 5, the threshold Gmax, the threshold Gmid, and the threshold Gmin of the acceleration were respectively used as the thresholds that determine the driving preferences, these may be substituted for a threshold Tmax, a threshold Tmid, and a threshold Tmin of the instruction torque Tq.

While a preferred embodiment of the invention has been described and illustrated above, it should be understood that this is an exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A controller of a motor for a vehicle comprising:
a motor that has a plurality of rotors which respectively have a magnetic piece, and for which mutual relative phases are changeable, which drives or supplementarily drives a vehicle;
a phase changing device that changes the relative phases of said plurality of rotors and performs adjustment to a predetermined induced voltage constant;
a measuring device that measures an acceleration state quantity of said vehicle; and
an induced voltage changing device that changes said induced voltage constant based on said acceleration state quantity measured by said measuring device.

2. The controller of a motor for a vehicle according to claim 1, wherein
said phase changing device changes said induced voltage constant according to a magnitude of an average value of said acceleration state quantity within a fixed interval.

3. The controller of a motor for a vehicle according to claim 2, wherein
said phase changing device is provided with maps of induced voltage constants, in which a plurality have been set, and selects one map from within said plurality of maps according to a magnitude of an average value of the acceleration state quantity at a fixed interval.

4. The controller of a motor for a vehicle according to claim 2, further comprising a reporting device that reports driving preferences of a driver according to a magnitude of an average value of said acceleration state quantity at a fixed interval.

5. The controller of a motor for a vehicle according to claim 1, wherein
said phase changing device is provided with maps of induced voltage constants, in which a plurality have been set, and selects one map from within said plurality of maps according to a magnitude of an average value of the acceleration state quantity at a fixed interval.

6. The controller of a motor for a vehicle according to claim 5, further comprising a reporting device that reports driving preferences of a driver according to a magnitude of an average value of said acceleration state quantity at a fixed interval.

7. The controller of a motor for a vehicle according to claim 5, wherein
said phase changing device is provided with a manual operation device in which said maps are able to be manually changed and fixed.

8. The controller of a motor for a vehicle according to claim 1, further comprising a reporting device that reports driving preferences of a driver according to a magnitude of an average value of said acceleration state quantity at a fixed interval.
